(19) United States
(12) Patent Application Publication
(10) Pub. No.: US 2023/0388617 A1
(43) Pub. Date: Nov. 30, 2023

(54) Barcode Scanner with Vision System and Shared Illumination

(71) Applicant: ZEBRA TECHNOLOGIES CORPORATION, Lincolnshire, IL (US)

(72) Inventors: Edward Barkan, Miller Place, NY (US); Mark Drzymala, Saint James, NY (US); Darran Michael Handshaw, Sound Beach, NY (US)

(21) Appl. No.: 17/828,759

(22) Filed: May 31, 2022

(51) Int. Cl. H04N 5/225; H04N 5/235

(52) U.S. Cl. CPC H04N 5/2256; H04N 5/2354; H04N 5/2353

(57) ABSTRACT

An imaging system with a shared illumination source is disclosed herein. An example imaging system includes an illumination source configured to emit an illumination pulse that provides illumination during a predetermined period, a first imaging apparatus, a second imaging apparatus, and a processor. The first imaging apparatus comprises: a first imaging sensor configured to capture first image data, and a first imaging control circuitry configured to expose the first imaging sensor. The second imaging apparatus comprises: a second imaging sensor configured to capture second image data, and a second imaging control circuitry configured to expose the second imaging sensor. The processor is configured to: receive the first image data and the second image data, perform an indicia decoding analysis on the second image data, and perform an image analysis on the first image data that does not include the indicia decoding analysis.

### BACKGROUND

Barcode scanning devices that include visual imaging systems are commonly utilized in many retail and other locations. Such devices typically include multiple illumination sources to provide different illumination for the barcode scanning function and the visual imaging function. For example, a conventional barcode scanning device may alternate illumination between red illumination for the barcode scanner and white illumination for the visual imager. However, as a result, these conventional devices draw significant amounts of power to drive the multiple illumination sources, resulting in reduced battery life of cordless devices and higher overall operational costs of corded devices. Conventional devices also require substantial amounts of space in order to house the multiple illumination sources, which decreases the space available for additional devices, increases construction complexity, and/or eliminates the possibility for additional features within each device. Moreover, conventional devices necessitate highly refined pulse timings of the different illumination sources in order to ensure that the different imagers (barcode scanner and visual imager) are able to capture image data under the correct lighting conditions. Consequently, these conventional devices are only able to capture images in a very inflexible manner that further constrains the power requirements of the device by forcing the illumination sources to emit illumination for specific durations and at specific, non-overlapping intervals.

Accordingly, there is a need for barcode scanning devices with visual imaging systems that include a shared illumination source in order to minimize the power, space, and timing requirements of conventional devices.

### SUMMARY

Generally speaking, the imaging systems herein utilize multiple imaging apparatuses and a single illumination source to capture image data of a target object and an indicia associated with the target object using illumination from the single illumination source. In particular, the single illumination source may be a white light illumination source configured to emit white light illumination during an predetermined period, in which, the imaging apparatuses will capture image data of the target object and/or the indicia. In certain embodiments, the multiple imaging apparatuses may be a single imaging apparatus with multiple imaging sensors (e.g., a first imaging sensor configured for barcode scanning, a second imaging sensor configured for visual imaging).

Accordingly, in an embodiment, the present invention is an imaging system. The imaging system includes an illumination source configured to emit an illumination pulse that provides illumination during a predetermined period; a first imaging apparatus having a first field of view (FOV), comprising: a first imaging sensor configured to capture first image data representative of an environment appearing within the first FOV during a first period that overlaps at least partially with the predetermined period, and a first imaging control circuitry configured to expose the first imaging sensor for the first period in order to capture the first image data; a second imaging apparatus having a second FOV that at least partially overlaps the first FOV, comprising: a second imaging sensor configured to capture second image data representative of an environment appearing within the second FOV during a second period that overlaps at least partially with the predetermined period, and a second imaging control circuitry configured to expose the second imaging sensor for the second in order to capture the second image data; and a processor configured to: receive the first image data from the first imaging apparatus and the second image data from the second imaging apparatus, perform an indicia decoding analysis on the second image data, and perform an image analysis on the first image data that does not include the indicia decoding analysis.

In a variation of this embodiment, the first period is greater than the second period, and the predetermined period is based on the first period.

In another variation of this embodiment, the first imaging control circuitry is further configured to expose the first imaging sensor for the first period that is at least partially not during the predetermined period.

In yet another variation of this embodiment, the second imaging control circuitry is further configured to expose the second imaging sensor for the second period that is at least partially not during the predetermined period.

In still another variation of this embodiment, the first imaging sensor and the second imaging sensor are color imaging sensors, and the illumination source comprises three light sources that each emit a distinct wavelength at a respective predetermined intensity, such that a combined output of the three light sources causes the illumination pulse to provide a white appearance to a user that lasts the predetermined period.

In yet another variation of this embodiment, the second imaging sensor is a monochrome imaging sensor.

In still another variation of this embodiment, the first imaging control circuitry is configured to expose the first imaging sensor for the first period that is entirely during the predetermined period, and the second imaging control circuitry is configured to expose the second imaging sensor for the second period that is entirely during the predetermined period. Still further in this variation, the first imaging control circuitry is configured to expose the first imaging sensor at a first time defining a beginning of the first period, and the second imaging control circuitry is configured to expose the second imaging sensor at a second time defining a beginning of the second period that is different from the beginning of the first period.

In yet another variation of this embodiment, the first imaging sensor and the second imaging sensor are a single imaging sensor.

In still another variation of this embodiment, the illumination source is further configured to emit the illumination pulse that provides illumination lasting the predetermined period.

In yet another variation of this embodiment, the first FOV is larger than the second FOV.

In still another variation of this embodiment, the processor is further configured to: perform the image analysis on the first image data that includes at least one of: (i) facial recognition, (ii) scan avoidance detection, (iii) ticket switching detection, (iv) item recognition, or (v) video feed analysis.

In yet another variation of this embodiment, the illumination source is configured to emit a plurality of illumination pulses that each provide illumination during a respective predetermined period, the first imaging control circuitry is configured to expose the first imaging sensor for the first period during a first respective predetermined period, the illumination provided during the first respective predetermined period has a first brightness, the second imaging control circuitry is configured to expose the second imaging sensor for the second period that is different from the first period, and that is during a second respective predetermined period that is different from the first respective predetermined period, and the illumination provided during the second respective predetermined period has a second brightness that is different from the first brightness.

In still another variation of this embodiment, the first imaging control circuitry is configured to expose the first imaging sensor in response to a signal generated by the illumination source upon emission of the illumination pulse, and the second imaging control circuitry is configured to expose the second imaging sensor in response to the signal generated by the illumination source upon emission of the illumination pulse.

In yet another variation of this embodiment, the first imaging apparatus and the second imaging apparatus are configured to transmit an exposure signal to the illumination source in order to cause the illumination source to emit the illumination pulse when (i) the first imaging control circuitry exposes the first imaging sensor for the first period or (ii) the second imaging control circuitry exposes the second imaging sensor for the second period.

In another embodiment, the present invention is a tangible machine-readable medium comprising instructions that, when executed, cause a machine to at least: emit an illumination pulse that provides illumination during a predetermined period; expose a first imaging sensor for a first period that is at least partially during the predetermined period in order to capture first image data representative of an environment appearing within a first field of view (FOV); expose a second imaging sensor for a second period that is at least partially during the predetermined period in order to capture second image data representative of an environment appearing within a second FOV; perform an indicia decoding analysis on the second image data; and perform an image analysis on the first image data that does not include the indicia decoding analysis.

In a variation of this embodiment, the first period is greater than the second period, and the predetermined period is based on the first period.

In another variation of this embodiment, the instructions, when executed, further cause the machine to at least: expose the first imaging sensor for the first period that is at least partially not during the predetermined period, and expose the second imaging sensor for the second period that is at least partially not during the predetermined period.

In yet another variation of this embodiment, the instructions, when executed, further cause the machine to at least: expose the first imaging sensor for the first period that is entirely during the predetermined period, wherein the first imaging sensor is exposed at a first time defining a beginning of the first period, and expose the second imaging sensor for the second period that is entirely during the predetermined period, wherein the second imaging sensor is exposed at a second time defining a beginning of the second period that is different from the beginning of the first period.

In still another variation of this embodiment, the instructions, when executed, further cause the machine to at least: emit a plurality of illumination pulses that each provide illumination during a respective predetermined period, expose the first imaging sensor for the first period during a first respective predetermined period, wherein the illumination provided during the first respective predetermined period has a first brightness, and expose the second imaging sensor for the second period that is different from the first period, and that is during a second respective predetermined period that is different from the first respective predetermined period, wherein the illumination provided during the second respective predetermined period has a second brightness that is different from the first brightness.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a prior art bioptic barcode reader, implemented in a prior art point-of-sale (POS) system, showing capture of an image of a target object.

FIG. 2A illustrates a profile view of an example imaging system that includes a first imaging apparatus, a second imaging apparatus, and a shared illumination source, in accordance with embodiments disclosed herein.

FIG. 2B is a block diagram of an example logic circuit for implementing example methods and/or operations described herein.

FIG. 3A is a graph illustrating a first exemplary activation sequence of the shared illumination source, a first imaging apparatus, and a second imaging apparatus, in accordance with embodiments disclosed herein.

FIG. 3B is a graph illustrating a second exemplary activation sequence of the shared illumination source, a first imaging apparatus, and a second imaging apparatus, in accordance with embodiments disclosed herein.

FIG. 3C is a graph illustrating a third exemplary activation sequence of the shared illumination source, a first imaging apparatus, and a second imaging apparatus, in accordance with embodiments disclosed herein.

FIG. 3D is a graph illustrating a fourth exemplary activation sequence of the shared illumination source, a first imaging apparatus, and a second imaging apparatus, in accordance with embodiments disclosed herein.

FIG. 3E is a graph illustrating a fifth exemplary activation sequence of the shared illumination source, a first imaging apparatus, and a second imaging apparatus, in accordance with embodiments disclosed herein.

FIG. 3F is a graph illustrating a sixth exemplary activation sequence of the shared illumination source, a first imaging apparatus, and a second imaging apparatus, in accordance with embodiments disclosed herein.

FIG. 4 illustrates an example method for capturing image data by a first imaging apparatus and a second imaging apparatus with a shared illumination source, in accordance with embodiments disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

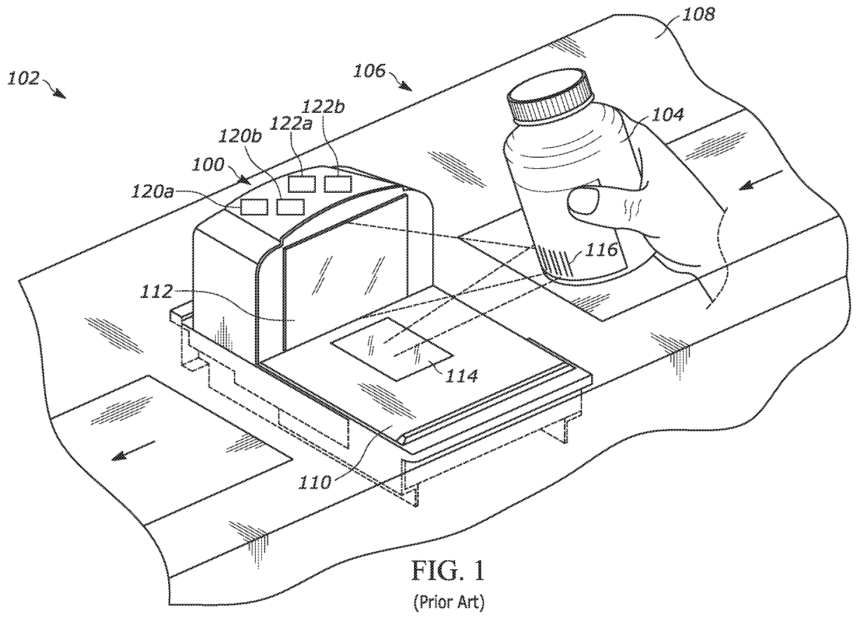

FIG. 1 is a perspective view of a prior art bioptic barcode reader 100, implemented in a prior art point-of-sale (POS) system 102, showing capture of an image of a target object 104 being swiped across the bioptic barcode reader 100 scanning area. The POS system 102 includes a workstation 106 with a counter 108, and the bioptic barcode reader 100. The bioptic barcode reader 100 includes a weighing platter 110, which may be a removable or a non-removable. Typically, a customer or store clerk will pass the target object 104 across at least one of a substantially vertical imaging window 112 or a substantially horizontal imaging window 114 to enable the bioptic barcode reader 100 to capture one or more images of the target object 104, including the barcode 116.

As part of the clerk passing the target object 104 across the imaging windows 112, 114, the bioptic barcode reader 100 may trigger illumination sources 120a, 120b included in the reader 100 to emit illumination, and for one or more imaging sensors 122a, 122b to capture image data of the target object 104 and/or the barcode 116. The illumination sources 120a, 120b may emit different illumination (e.g., white light, red light, etc.) depending on the imaging sensor currently configured to capture image data. For example, a first illumination source 120a may emit red light to illuminate the target object 104 when a barcode scanning sensor 122a is activated to capture image data, and a second illumination source 120b may emit white light to illuminate the target object 104 when a visual imaging sensor 122b is activated to capture image data. Moreover, when the first illumination source 120a emits the red light illumination, the second illumination source 120b may not emit white light illumination, and the visual imaging sensor 122b may not capture image data. Conversely, when the second illumination source 120b emits white light illumination, the first illumination source 120a may not emit the red light illumination, and the barcode scanning sensor 122a may not capture image data.

As an example, the first illumination source 120a may include multiple red light emitting diodes (LEDs) on each side of the barcode scanning sensor 122a, and the second illumination source 120b may include multiple white LEDs on each side of the visual imaging sensor 122b. When a clerk or customer passes the target object 104 in front of either scanning window 112, 114, the bioptic barcode reader 100 may activate the first illumination source 120a to emit red light illumination, and the reader 100 may activate the barcode scanning sensor 122a to capture image data of the barcode 116. Once the barcode scanning sensor 122a has captured image data of the barcode 116, the reader 100 may deactivate the first illumination source 120a and may activate the second illumination source 120b to emit white light illumination. Accordingly, the reader 100 may also activate the visual imaging sensor 122b to capture image data of the target object 104 using the white light illumination from the second illumination source 120b.

However, as previously mentioned, this conventional activation sequence involving multiple illumination sources 120a, 120b yields several undesirable results. Namely, conventional devices similar to the prior art bioptic barcode reader 100 draw significant amounts of power to drive the multiple illumination sources 102a, 120b, resulting in higher overall operational costs of such corded devices. Additionally, conventional devices that are handheld and/or otherwise utilize batteries to power operation of the multiple illumination sources 120a, 120b suffer from reduced operational life of the device particularly because the illumination sources 120a, 120b require nearly double the power requirements of a single illumination source.

Conventional devices similar to the prior art bioptic barcode reader 100 also require substantial amounts of space in order to house the multiple illumination sources, which decreases the space available for additional devices, increases construction complexity, and/or eliminates the possibility for additional features within each device. Such conventional devices (e.g., the prior art bioptic barcode reader 100) may also aggravate users as these multiple illumination sources rapidly alternate between different illumination colors that are stressful on the users' eyes. Moreover, conventional devices similar to the prior art bioptic barcode reader 100 necessitate highly refined pulse timings of the different illumination sources 120a, 120b in order to ensure that the different imagers 122a, 122b are able to capture image data under the correct lighting conditions. For example, and as previously discussed, when the first illumination source 120a emits illumination enabling the barcode scanning sensor 122a to capture image data, the visual imaging sensor 122b is unable to capture image data until the red light illumination emitted from the first illumination source 120a has substantially reduced in amplitude. Consequently, conventional devices similar to the prior art bioptic barcode reader 100 are only able to capture images in a very inflexible manner that further constrains the power requirements of the device by forcing the illumination sources 120a, 120b to emit illumination for specific durations and at specific, non-overlapping intervals.

More specifically, conventional devices suffer from requiring multiple illumination sources due to the contrasting imaging requirements, image sensors, and corresponding end goals of barcode scanners and visual imagers. Barcode imagers typically include monochromatic sensors configured to operate with relatively short exposure periods that freeze an indicia in place during image capture (e.g., minimizing blur) without sacrificing a sufficiently high number of pixels per module (PPM) in order to accurately decode the indicia payload. On the other hand, visual imagers typically include color sensors configured to operate with relatively longer exposure periods in order to acquire sufficient color data and brightness to perform accurate image analysis that does not necessarily require negligible image blur. Thus, these differences have forced manufacturers/operators to conventionally rely on multiple illumination sources to provide the requisite illumination. However, to resolve these issues with conventional devices, the imaging systems of the present disclosure provide a single illumination source configured to provide illumination that is suitable for barcode decoding as well as visual image analysis.

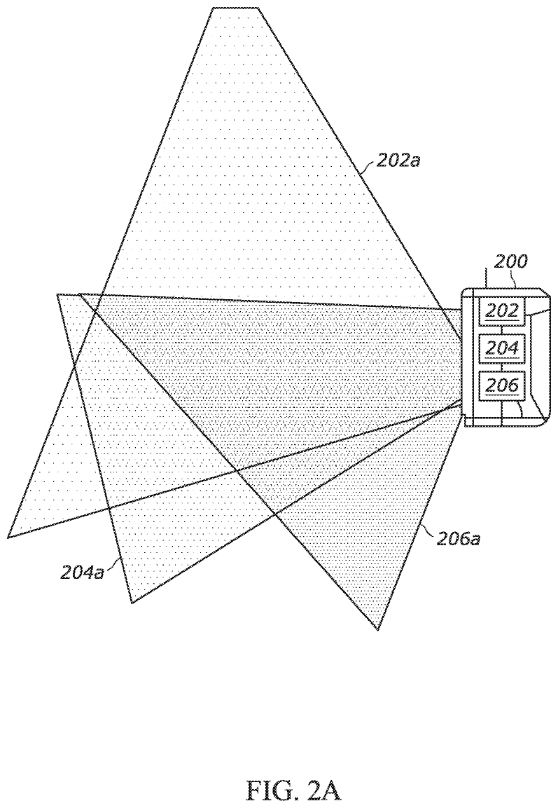

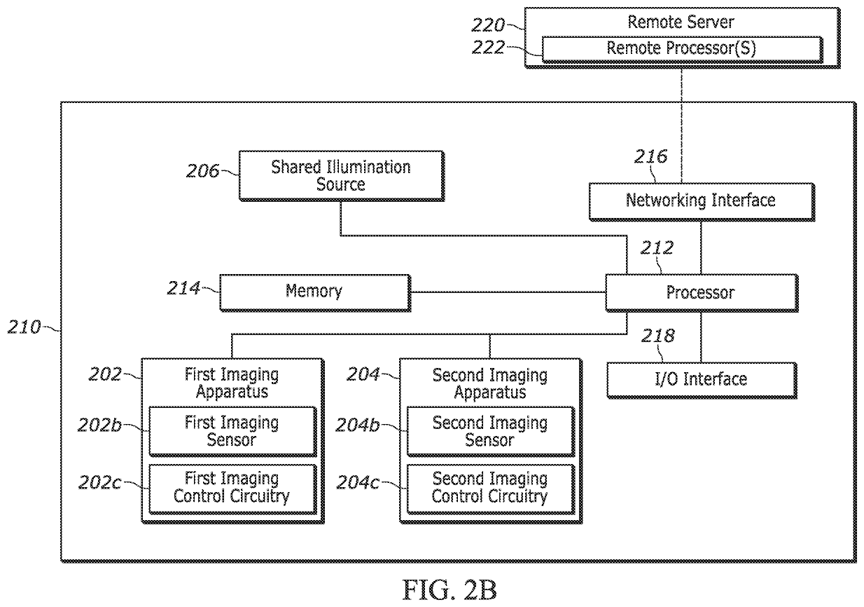

To illustrate, FIG. 2A provides a profile view of an example imaging system 200 that includes a first imaging apparatus 202, a second imaging apparatus 204, and a shared illumination source 206, in accordance with embodiments disclosed herein. The example imaging system 200 may be any suitable type of imaging device, such as a bioptic barcode scanner, a slot scanner, an original equipment manufacturer (OEM) scanner inside of a kiosk, a handle/handheld scanner, and/or any other suitable imaging device type. For ease of discussion only, the example imaging system 200 may be described herein as a vertical imaging tower of a bioptic barcode scanner.

Generally speaking, the first imaging apparatus 202 may be a visual imager (also referenced herein as a “vision camera”) with one or more visual imaging sensors that are configured to capture one or more images of a target object. The second imaging apparatus 204 may be a barcode scanner with one or more barcode imaging sensors that are configured to capture one or more images of an indicia associated with the target object. The shared illumination source 206 may generally be configured to emit an illumination pulse that provides illumination during an predetermined period. The first imaging apparatus 202 and the second imaging apparatus 204 may be configured to capture image data during the predetermined period, thereby utilizing at least some of the same illumination provided by the illumination pulse emitted from the shared illumination source 206.

In some embodiments, the first imaging apparatus 202 and the second imaging apparatus 204 may use and/or include color sensors and the shared illumination source 206 may emit white light illumination via the illumination pulse. As referenced herein, “white” light/illumination may include multiple wavelengths of light within a wavelength range generally extending from about 400 nm to about 700 nm. In particular, the “white” light/illumination emitted by the shared illumination source 206 may result from the shared illumination source 206 comprising three light sources that each emit a distinct wavelength (e.g., approximately 440 nm, 560 nm, and 635 nm) at a respective predetermined intensity, such that a combined output of the three light sources causes the illumination pulse emitted from the shared illumination source 206 to provide a white appearance to a user that lasts the predetermined period. Of course, it should be understood that “white” light referenced herein may include any suitable number of wavelengths (e.g., 7 distinct wavelengths) and/or may be generated by any suitable configuration of wavelengths (e.g., violet/ultraviolet LED and phosphor emission). Additionally, or alternatively, the second imaging apparatus 204 may use and/or include a monochrome sensor configured to capture image data of an indicia associated with the target object in a particular wavelength or wavelength range (e.g., 600 nanometers (nm)-700 nm).

More specifically, the first imaging apparatus 202 and the second imaging apparatus 204 may each include subcomponents, such as one or more imaging sensors (not shown) and imaging shutters (not shown) that are configured to enable the imaging apparatuses 202, 204 to capture image data corresponding to a target object and/or an indicia associated with the target object. It should be appreciated that the imaging shutters included as part of the imaging apparatuses 202, 204 may be electronic and/or mechanical shutters configured to expose/shield the imaging sensors of the apparatuses 202, 204 from the external environment. Such image data may comprise 1-dimensional (1D) and/or 2-dimensional (2D) images of a target object, including, for example, packages, products, or other target objects that may or may not include barcodes, QR codes, or other such labels for identifying such packages, products, or other target objects, which may be, in some examples, merchandise available at retail/wholesale store, facility, or the like. A processor (e.g., processor 212 of FIG. 2B) of the example imaging system 200 may thereafter analyze the image data of target objects and/or indicia passing through a scanning area or scan volume of the example imaging system 200.

The first imaging apparatus 202 may have a first field of view (FOV) 202a, and the second imaging apparatus 204 may have a second FOV 204a that at least partially overlaps the first FOV 202a. As illustrated in FIG. 2A, the first FOV 202a and the second FOV 204a may include different portions of the external environment of the example imaging system 200. For example, the first FOV 202a may extend above the second FOV 204a, and as a result, the first imaging apparatus 202 may capture image data of a portion of the external environment that the second imaging apparatus 204 may not capture. Further, the second FOV 204a may extend below the first FOV 202a, and as a result, the second imaging apparatus 204 may capture image data of a portion of the external environment that the first imaging apparatus 202 may not capture.

These differences in the FOVs 202a, 204a may be benefit the respective imaging apparatuses 202, 204. Namely, the second FOV 204a may be oriented and sized such that the images captured by the second imaging apparatus 204 have sufficient resolution to successfully decode barcodes and/or other indicia (e.g., quick response (QR) codes, etc.) included in the image data. Similarly, the first FOV 202a may be oriented and sized appropriately to optimize the captured images for a vision application performed by the example imaging system 200. For example, the first imaging apparatus 202 may capture image data, and the example imaging system 200 may perform image analysis on the image data that includes at least one of: (i) facial recognition, (ii) scan avoidance detection, (iii) ticket switching detection, (iv) item recognition, or (v) video feed analysis.

Typically, the first FOV 202a may be larger than the second FOV 202b because the first imaging apparatus 202 may not require the same level of resolution in captured images as the second imaging apparatus 204. In particular, unlike the image data captured by the second imaging apparatus 204, the image data captured by the first imaging apparatus 202 is not typically evaluated for decoding of indicia. Thus, as an example, the first FOV 202a may be or include a relatively large region of the external environment in order to acquire enough visual data that would enable the example imaging system 200 to perform scan avoidance detection (e.g., clerk or customer pretending to scan an item without actually passing the indicia associated with the item across the scanning windows or FOVs). As another example, the first FOV 202a may be relatively large to enable the example imaging system 200 to perform product identification for large items or to enable multiple different focuses depending on the item of interest.

As mentioned, the shared illumination source 206 may generally emit illumination pulses within a wavelength range generally corresponding to white light illumination. For example, each illumination pulse may include light within a wavelength range generally extending from about 400 nm to about 700 nm. In particular, the shared illumination source 206 may comprise three light sources that each emit a distinct wavelength at a respective predetermined intensity, such that a combined output of the three light sources causes the illumination pulse to provide a white appearance to a user that lasts the predetermined period. Generally, as previously mentioned, the shared illumination source 206 may emit an illumination pulse, and the illumination pulse may last for a duration that defines an predetermined period. During the predetermined period, both the first imaging apparatus 202 and the second imaging apparatus 204 may proceed to capture image data corresponding to the target object and/or the indicia associated with the target object. Thus, the imaging shutters for both the first imaging apparatus 202 and the second imaging apparatus 204 may be configured to expose the first imaging apparatus 202 and the second imaging apparatus 204 while an illumination pulse provides illumination defining a single predetermined period.

As an example, a clerk may bring a target object into the FOVs 202a, 204a of the imaging apparatuses 202, 204, and the example imaging system 200 may cause the shared illumination source 206 to emit an illumination pulse, thereby providing illumination lasting an predetermined period. The imaging shutter of the second imaging apparatus 204 may actuate to expose the imaging sensors of the second imaging apparatus 204 when the shared illumination source 206 emits the illumination pulse in order for the second imaging apparatus 204 to capture image data corresponding to an indicia associated with the target object. The imaging shutter of the second imaging apparatus 204 may actuate, for example, nearly simultaneously with the shared illumination source 206 emitting the illumination pulse. Further, the imaging shutter of the first imaging apparatus 202 may actuate to expose the imaging sensors of the first imaging apparatus 202 slightly after the shared illumination source 206 emits the illumination pulse, but while the illumination pulse continues to provide illumination sufficient to enable the first imaging apparatus to capture image data corresponding to the target object. Moreover, both imaging apparatuses may conclude respective exposures within the predetermined period, such that the image data captured by both apparatuses 202, 204 received constant illumination from the single illumination pulse. In this manner, both imaging apparatuses 202, 204 may capture image data during the predetermined period using the illumination provided by a single illumination pulse emitted from the shared illumination source 206.

In certain embodiments, the duration of the predetermined period may be based on the exposure duration requirements of the respective apparatuses 202, 204. For example, the second imaging apparatus 204 may have a relatively short exposure requirement in order to achieve the necessary resolution for decoding an indicia associated with a target object. By contrast, the first imaging apparatus 202 may have a relatively long exposure requirement in order to achieve the necessary color and brightness to perform object recognition and/or other visual analysis tasks (e.g., facial recognition, scan avoidance detection, ticket switching detection, item recognition, video feed analysis, etc.). Thus, in these embodiments, the predetermined period may be long enough such that the exposure period of the first imaging apparatus 202 may fit entirely within the predetermined period.

Additionally, or alternatively, the shared illumination source 206 may emit individual illumination pulses for each imaging apparatus 202, 204, and the individual illumination pulses may define predetermined periods of different lengths based on the exposure periods of the respective imaging apparatuses 202, 204. For example, the shared illumination source 206 may emit a first illumination pulse that provides illumination lasting a first predetermined period, and the imaging shutter for the second imaging apparatus 204 may expose the second imaging apparatus 204 during the first predetermined period to capture image data corresponding to an indicia associated with a target object. When the first illumination pulse stops providing illumination, the shared illumination source 206 may emit a second illumination pulse that provides illumination lasting a second predetermined period, and the imaging shutter for the first imaging apparatus 202 may expose the first imaging apparatus 202 during the second predetermined period to capture image data corresponding to the target object.

In some embodiments, the first imaging apparatus 202 and/or the second imaging apparatus 204 may generate and transmit a signal to the shared illumination source 206 to cause the source 206 to emit illumination pulses in synchronization with an exposure period of the first imaging apparatus 202 and/or the second imaging apparatus 204. For example, the first imaging apparatus 202 may generate and transmit a signal to the shared illumination source 206 indicating that the apparatus 202 has an exposure period that is longer than the exposure period of the second imaging apparatus 204. As a result, the shared illumination source 206 may adjust the emission time of the illumination pulse to ensure that the exposure period of the first imaging apparatus 202 falls entirely within the predetermined period defined by the illumination pulse. Additionally, or alternatively, the signal transmitted to the shared illumination source 206 may indicate that the first imaging apparatus 202 and/or the second imaging apparatus 204 is configured to capture image data (e.g., expose) during a start time and an end time, during which, the shared illumination source is not configured to emit an illumination pulse. Responsive to receiving the signal, the shared illumination source 206 may emit an illumination pulse at the start time of the exposure period for the respective imaging apparatus 202, 204 to ensure that the respective imaging apparatus 202, 204 has adequate illumination while capturing image data. This may be of particular use, for example, when the first imaging apparatus 202, the second imaging apparatus 204, and/or any other imaging apparatus is an external imaging apparatus that is not included within a housing of the example imaging system 200.

Moreover, in certain embodiments, the shared illumination source 206 may trigger the exposure of the first imaging apparatus 202 and/or the second imaging apparatus 204. For example, the shared illumination source 206 may emit an illumination pulse, and simultaneously send an activation signal to the first imaging apparatus 202 and/or the second imaging apparatus 204 in order to cause either or both apparatuses to capture image data during the predetermined period. The shared illumination source 206 may cause both imaging apparatuses 202, 204 to expose simultaneously, and/or the source 206 may send two signals during the predetermined period to stagger the exposure of the apparatuses 202, 204 during the predetermined period. For example, the shared illumination source 206 may transmit a first activation signal to the second imaging apparatus 204 simultaneously with the emission of the illumination pulse, and the source 206 may transmit a second activation signal to the first imaging apparatus sometime after the first activation signal but still within the predetermined period defined by the illumination pulse.

Additionally, or alternatively, in certain embodiments, the exposure periods for one or both of the imaging apparatuses 202, 204 may exceed the predetermined period. The predetermined period may not provide one or both of the imaging apparatuses 202, 204 adequate time to capture the image data, and as a result, one or both of the imaging apparatuses 202, 204 may need to expose for a duration that extends beyond/before the predetermined period to ensure the sensors are adequately exposed to the external environment. For example, the first imaging apparatus 204 may begin exposure after the second imaging apparatus 204, and may require a longer exposure period than the second imaging apparatus 204. The first imaging apparatus 202 may continue exposing the imaging sensors after the illumination from the illumination pulse has ceased, and the imaging sensors of the first imaging apparatus 202 may rely on ambient illumination to provide further illumination during the remaining exposure. As another example, the second imaging apparatus 204 may begin exposure to the external environment before the shared illumination source 206 emits an illumination pulse. Thus, the second imaging apparatus 204 may also rely, in part, on ambient light to provide illumination during an exposure period of the imaging sensors of the second imaging apparatus 204.

In some embodiments, the shared illumination source 206 may include multiple LEDs and multiple lenses in order to provide optimal illumination for the first imaging apparatus 202 and the second imaging apparatus 204. Some of the multiple lenses and/or the multiple LEDs may be optimally configured to provide illumination for the second imaging apparatus 204, such that some/all of the second FOV 204a is illuminated with light that optimally illuminates the indicia associated with the target object for indicia payload decoding. Similarly, some of the multiple lenses and/or the multiple LEDs may be optimally configured to provide illumination for the first imaging apparatus 202, such that some/all of the first FOV 202a is illuminated with light that optimally illuminates the target object for various visual analysis tasks. For example, when emitting an illumination pulse, during which, the second imaging apparatus 204 is exposed to capture image data, the shared illumination source 206 may utilize a first LED and a first lens to illuminate the second FOV 204a. When emitting an illumination pulse, during which, the first imaging apparatus 202 is exposed to capture image data, the shared illumination source 206 may utilize the first LED, a second LED, a third LED, and a second lens to illuminate the first FOV 202a.

FIG. 2B is a block diagram representative of an example logic circuit capable of implementing, for example, one or more components of the example imaging system 200 of FIG. 2A. The example logic circuit of FIG. 2B is a processing platform 210 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 210 of FIG. 2B includes a processor 212 such as, for example, one or more microprocessors, controllers, and/or any suitable type of processor. The example processing platform 210 of FIG. 2B includes memory (e.g., volatile memory, non-volatile memory) 214 accessible by the processor 212 (e.g., via a memory controller). The example processor 212 interacts with the memory 214 to obtain, for example, machine-readable instructions stored in the memory 214 corresponding to, for example, the operations represented by the flowcharts of this disclosure. The example processor 212 may also interact with the memory 214 to obtain, or store, instructions related to the first imaging apparatus 202, the second imaging apparatus 204, and/or the shared illumination source 206.

Additionally, or alternatively, machine-readable instructions corresponding to the example operations described herein may be stored on one or more removable media (e.g., a compact disc, a digital versatile disc, removable flash memory, etc.) that may be coupled to the processing platform 210 to provide access to the machine-readable instructions stored thereon.

As illustrated in FIG. 2B, the first imaging apparatus 202 includes a first imaging sensor(s) 202b and a first imaging control circuitry 202c, and the second imaging apparatus 204 includes a second imaging sensor(s) 204b and a second imaging control circuitry 204c. As previously mentioned, each of the first imaging control circuitry 202c and/or the second imaging control circuitry 204c may be mechanical or electronic shutters configured to expose the first imaging sensor(s) 202b and/or the second imaging sensor(s) 204b to an external environment for image data capture. Moreover, each of the first imaging sensor(s) 202b and/or the second imaging sensor(s) 204b may include one or more sensors configured to capture image data corresponding to a target object, an indicia associated with the target object, and/or any other suitable image data.

The example processing platform 210 of FIG. 2B also includes a network interface 216 to enable communication with other machines via, for example, one or more networks. The example network interface 216 includes any suitable type of communication interface(s) (e.g., wired and/or wireless interfaces) configured to operate in accordance with any suitable protocol(s). For example, in some embodiments, networking interface 216 may transmit data or information (e.g., imaging data, illumination pulse emission signals, etc., described herein) between remote processor(s) 222 and/or remote server 220, and processing platform 210.

The example, processing platform 210 of FIG. 2B also includes input/output (I/O) interfaces 218 to enable receipt of user input and communication of output data to the user.

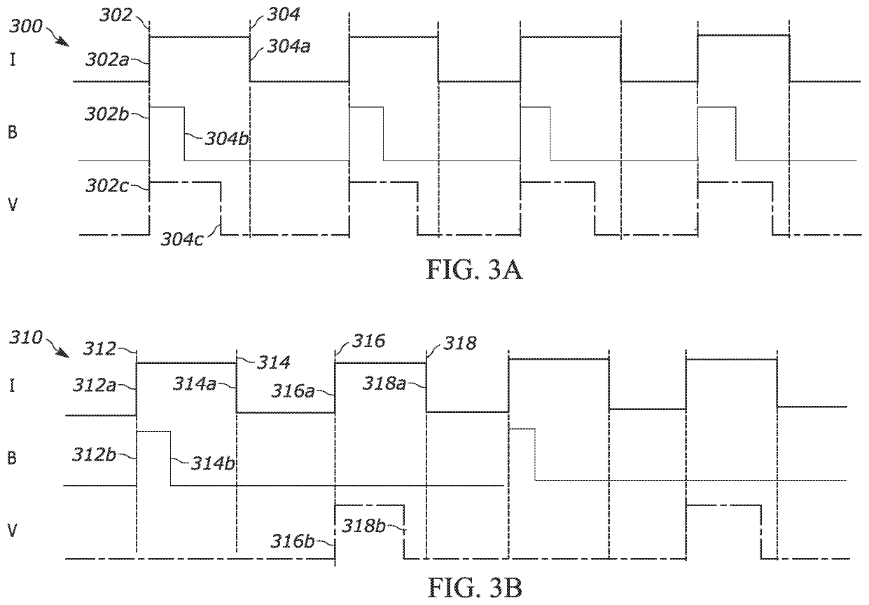

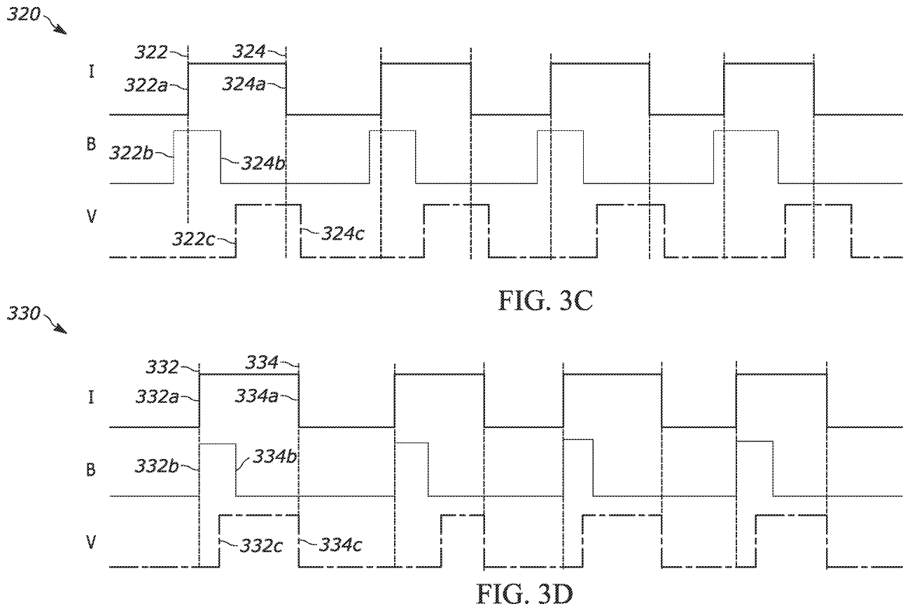

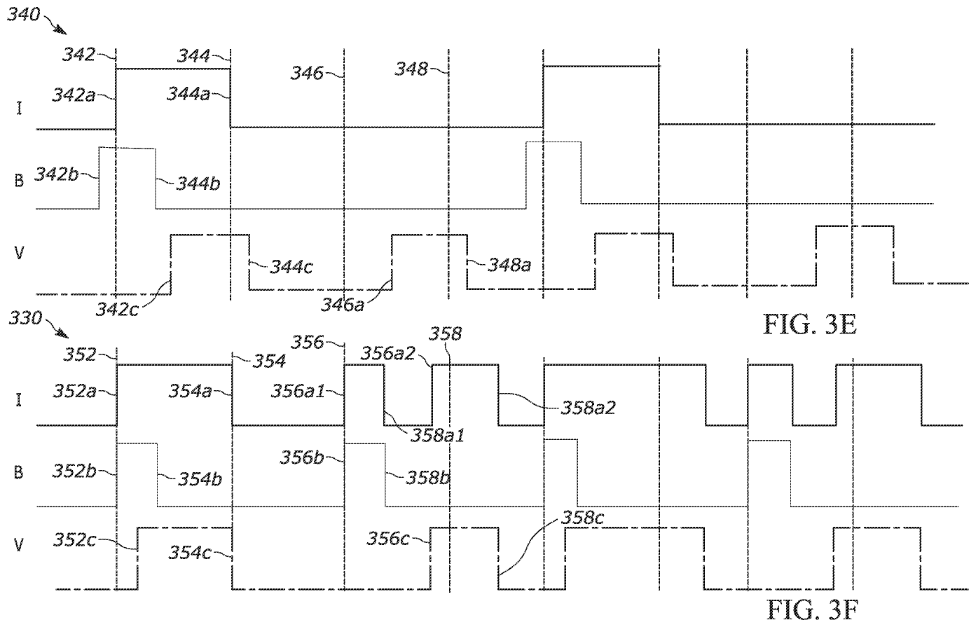

FIG. 3A is a graph 300 illustrating a first exemplary activation sequence of a shared illumination source (e.g., shared illumination source 206), a first imaging apparatus (e.g., first imaging apparatus 202), and a second imaging apparatus (e.g., second imaging apparatus 204), in accordance with embodiments disclosed herein. As illustrated in FIG. 3A, the graph 300 includes a first line (I) representing the illumination level provided by the shared illumination source 206, a second line (B) representing the exposure of a barcode imager (e.g., second imaging apparatus 204), and a third line (V) representing the exposure of a visual camera (e.g., first imaging apparatus 202). As previously described, the illumination pulses emitted by the shared illumination source 206 may define predetermined periods, during which, the imaging apparatuses may expose and capture image data. One such predetermined period is illustrated in FIG. 3A by the duration delineated by a first time 302 and a second time 304. It should be understood that an “predetermined period,” as described herein may be any period of time during which illumination from illumination pulses emitted by the shared illumination source 206 is present.

At the first time 302, the shared illumination source 206 may emit an illumination pulse, as represented by the increased level of illumination at point 302a on the first line I. In the first exemplary activation sequence, both imaging apparatuses may trigger their respective exposures based on this initial illumination pulse emission by the shared illumination source 206. Accordingly, the exposure of the second imaging apparatus 204 elevates simultaneously with the increased level of illumination at point 302a, as represented at point 302b on the second line B. Similarly, the exposure of the first imaging apparatus 202 elevates simultaneously with the increased level of illumination at point 302a, as represented at point 302c on the third line V.

However, as illustrated in FIG. 3A, the exposure times of the respective imaging apparatuses is not identical to one another, nor is it identical to the predetermined period. Namely, the exposure period for the second imaging apparatus 204 ends at point 304b, at which point, the imaging shutter for the second imaging apparatus 204 closes to stop the exposure of the imaging sensors of the second imaging apparatus 204. Thereafter, the exposure period for the first imaging apparatus 202 ends at point 304c, at which point, the imaging shutter for the first imaging apparatus 202 closes to stop the exposure of the imaging sensors of the first imaging apparatus 202. After both exposure periods for both imaging apparatuses 202, 204 have ended, the illumination level provided by the illumination pulse ends at point 304a. This sequence may repeat iteratively any suitable number of times in order to capture any sufficient number of images (e.g., frames) for any suitable image analysis purposes (e.g., indicia payload decoding, facial recognition, scan avoidance detection, etc.). Thus, in the first exemplary activation sequence illustrated in FIG. 3A, both exposure periods for both imaging apparatuses 202, 204 may begin and end entirely within the predetermined period that includes illumination from the illumination pulse lasting from point 302a to 304a on the first line I.

FIG. 3B is a graph 310 illustrating a second exemplary activation sequence of a shared illumination source (e.g., shared illumination source 206), a first imaging apparatus (e.g., first imaging apparatus 202), and a second imaging apparatus (e.g., second imaging apparatus 204), in accordance with embodiments disclosed herein. As illustrated in FIG. 3B, the graph 310 includes a first line (I) representing the illumination level provided by the shared illumination source 206, a second line (B) representing the exposure of a barcode imager (e.g., second imaging apparatus 204), and a third line (V) representing the exposure of a visual camera (e.g., first imaging apparatus 202). As previously described, the illumination pulses emitted by the shared illumination source 206 may define predetermined periods, during which, the imaging apparatuses may expose and capture image data. Two such predetermined periods are illustrated in FIG. 3B by the durations delineated by a first time 312 and a second time 314 (e.g., a “first predetermined period”), and a third time 316 and a fourth time 318 (e.g., a “second predetermined period”).

At the first time 312, the shared illumination source 206 may emit an illumination pulse, as represented by the increased level of illumination at point 312a on the first line I. In the second exemplary activation sequence, only the second imaging apparatus 204 may trigger an exposure of the corresponding imaging sensors based on this initial illumination pulse emission by the shared illumination source 206. Accordingly, the exposure of the second imaging apparatus 204 elevates simultaneously with the increased level of illumination at point 312a, as represented at point 312b on the second line B.

However, as illustrated in FIG. 3B, the initial exposure of the first imaging apparatus 202 is not synchronized with the initial exposure of the second imaging apparatus 204 at point 312b. Instead, the first imaging apparatus 202 may trigger an exposure of the corresponding imaging sensors at point 316b, which is synchronized with a subsequent illumination pulse emission from the shared illumination source 206, as represented by the increased level of illumination at point 316a on the first line I. In this manner, each imaging apparatus may synchronize an exposure with an individual illumination pulse that is not shared with the other imaging apparatus.

Moreover, the exposure times of the respective imaging apparatuses are not identical to one another, nor are the exposure times identical to the respective predetermined periods. Namely, the exposure period for the second imaging apparatus 204 ends at point 314b, at which point, the imaging shutter for the second imaging apparatus 204 closes to stop the exposure of the imaging sensors of the second imaging apparatus 204. The exposure period for the first imaging apparatus 202 ends at point 318b, at which point, the imaging shutter for the first imaging apparatus 202 closes to stop the exposure of the imaging sensors of the first imaging apparatus 202. After both exposure periods for both imaging apparatuses 202, 204 have ended, the illumination level provided by the respective illumination pulses ends at points 314a and 318a, respectively. This sequence may repeat iteratively any suitable number of times in order to capture any sufficient number of images (e.g., frames) for any suitable image analysis purposes (e.g., indicia payload decoding, facial recognition, scan avoidance detection, etc.). Thus, in the second exemplary activation sequence illustrated in FIG. 3B, both exposure periods for both imaging apparatuses 202, 204 may begin and end entirely within the predetermined period that includes illumination from two distinct illumination pulses lasting from point 312a to point 314a and from point 316a to point 318a on the first line I.

FIG. 3C is a graph 320 illustrating a third exemplary activation sequence of a shared illumination source (e.g., shared illumination source 206), a first imaging apparatus (e.g., first imaging apparatus 202), and a second imaging apparatus (e.g., second imaging apparatus 204), in accordance with embodiments disclosed herein. As illustrated in FIG. 3C, the graph 320 includes a first line (I) representing the illumination level provided by the shared illumination source 206, a second line (B) representing the exposure of a barcode imager (e.g., second imaging apparatus 204), and a third line (V) representing the exposure of a visual camera (e.g., first imaging apparatus 202). As previously described, the illumination pulses emitted by the shared illumination source 206 may define predetermined periods, during which, the imaging apparatuses may expose and capture image data. One such predetermined period is illustrated in FIG. 3C by the duration delineated by a first time 322 and a second time 324.

At the first time 322, the shared illumination source 206 may emit an illumination pulse, as represented by the increased level of illumination at point 322a on the first line I. In the third exemplary activation sequence, neither imaging apparatus may trigger a respective exposure based on this initial illumination pulse emission by the shared illumination source 206. In fact, the second imaging apparatus 204 may trigger an exposure of the corresponding imaging sensors prior to the emission of the initial illumination pulse from the shared illumination source 206, as represented at point 322b on the second line B. Further, the exposure of the first imaging apparatus 202 may elevate after the increased level of illumination at point 322a, as represented at point 322c on the third line V. In this manner, the exposure periods of the respective imaging apparatuses may be configured to avoid exposure overlap of the respective imaging apparatuses without significantly exposing the imaging sensors outside of the illumination pulse duration (e.g., from point 322a to point 324a).

Moreover, as illustrated in FIG. 3C, the exposure times of the respective imaging apparatuses are not identical to one another, nor are the exposure times identical to the predetermined period. Namely, the exposure period for the second imaging apparatus 204 ends at point 324b, at which point, the imaging shutter for the second imaging apparatus 204 closes to stop the exposure of the imaging sensors of the second imaging apparatus 204. Thereafter, the illumination level provided by the illumination pulse ends at point 324a. After both the exposure period for the second imaging apparatus 204 ends and the illumination level provided by the illumination pulse ends, the exposure period for the first imaging apparatus 202 ends at point 324c, at which point, the imaging shutter for the first imaging apparatus 202 closes to stop the exposure of the imaging sensors of the first imaging apparatus 202. This sequence may repeat iteratively any suitable number of times in order to capture any sufficient number of images (e.g., frames) for any suitable image analysis purposes (e.g., indicia payload decoding, facial recognition, scan avoidance detection, etc.). Thus, in the third exemplary activation sequence illustrated in FIG. 3C, both exposure periods for both imaging apparatuses 202, 204 may include a portion that is not within the predetermined period, and thereby does not include illumination from an illumination pulse emitted from the shared illumination source 206 (e.g., lasting from point 322a to point 324a on the first line I).

FIG. 3D is a graph 330 illustrating a fourth exemplary activation sequence of a shared illumination source (e.g., shared illumination source 206), a first imaging apparatus (e.g., first imaging apparatus 202), and a second imaging apparatus (e.g., second imaging apparatus 204), in accordance with embodiments disclosed herein. As illustrated in FIG. 3D, the graph 330 includes a first line (I) representing the illumination level provided by the shared illumination source 206, a second line (B) representing the exposure of a barcode imager (e.g., second imaging apparatus 204), and a third line (V) representing the exposure of a visual camera (e.g., first imaging apparatus 202). As previously described, the illumination pulses emitted by the shared illumination source 206 may define predetermined periods, during which, the imaging apparatuses may expose and capture image data. One such predetermined period is illustrated in FIG. 3D by the duration delineated by a first time 332 and a second time 334.

At the first time 332, the shared illumination source 206 may emit an illumination pulse, as represented by the increased level of illumination at point 332a on the first line I. In the fourth exemplary activation sequence, the second imaging apparatus 204 may trigger a respective exposure based on this initial illumination pulse emission by the shared illumination source 206, as represented by point 332b on the second line B. However, the exposure of the first imaging apparatus 202 may elevate after the increased level of illumination at point 322a, but prior to the end of the exposure period of the second imaging apparatus (e.g., at point 334b), as represented at point 332c on the third line V. In this manner, the exposure periods of the respective imaging apparatuses may be configured to include exposure overlap of the respective imaging apparatuses to avoid exposing the imaging sensors outside of the illumination pulse duration (e.g., from point 332a to point 334a).

Moreover, as illustrated in FIG. 3D, the exposure times of the respective imaging apparatuses are not identical to one another, nor are the exposure times identical to the predetermined period. Namely, the exposure period for the second imaging apparatus 204 ends at point 334b, at which point, the imaging shutter for the second imaging apparatus 204 closes to stop the exposure of the imaging sensors of the second imaging apparatus 204. Thereafter, both the exposure period for the first imaging apparatus 202 ends at point 334c, at which point, the imaging shutter for the first imaging apparatus 202 closes to stop the exposure of the imaging sensors of the first imaging apparatus 202; and the illumination level provided by the illumination pulse ends at point 334a. This sequence may repeat iteratively any suitable number of times in order to capture any sufficient number of images (e.g., frames) for any suitable image analysis purposes (e.g., indicia payload decoding, facial recognition, scan avoidance detection, etc.).

Thus, in the fourth exemplary activation sequence illustrated in FIG. 3D, both exposure periods for both imaging apparatuses 202, 204 may begin and end within the predetermined period, and may be configured such that the exposure period for the second imaging apparatus 204 begins with the emission of the illumination pulse at point 332a and the exposure period for the first imaging apparatus 202 ends with the end of the illumination provided by the illumination pulse at point 334a. In this manner, both imaging apparatuses 202, 204 may fully expose their respective imaging sensors within the predetermined period to take advantage of the illumination provided by the shared illumination source 206 while ensuring minimal overlap of their respective exposure periods.

FIG. 3E is a graph 340 illustrating a fifth exemplary activation sequence of a shared illumination source (e.g., shared illumination source 206), a first imaging apparatus (e.g., first imaging apparatus 202), and a second imaging apparatus (e.g., second imaging apparatus 204), in accordance with embodiments disclosed herein. As illustrated in FIG. 3E, the graph 340 includes a first line (I) representing the illumination level provided by the shared illumination source 206, a second line (B) representing the exposure of a barcode imager (e.g., second imaging apparatus 204), and a third line (V) representing the exposure of a visual camera (e.g., first imaging apparatus 202). As previously described, the illumination pulses emitted by the shared illumination source 206 may define predetermined periods, during which, the imaging apparatuses may expose and capture image data. One such predetermined period is illustrated in FIG. 3E by the duration delineated by a first time 342 and a second time 344 (e.g., a “first predetermined period”). Further, as illustrated in FIG. 3E, the first imaging apparatus may expose the corresponding imaging sensors outside of an predetermined period that is generally delineated by a third time 346 and a fourth time 348 (e.g., a “subsequent exposure period”).

At the first time 342, the shared illumination source 206 may emit an illumination pulse, as represented by the increased level of illumination at point 342a on the first line I. In the fifth exemplary activation sequence, the second imaging apparatus 204 may trigger an exposure of the corresponding imaging sensors prior to this initial illumination pulse emission by the shared illumination source 206. Further, the initial exposure of the first imaging apparatus 202 is not synchronized with the initial exposure of the second imaging apparatus 204 at point 342b, and instead, the first imaging apparatus 202 may trigger an exposure of the corresponding imaging sensors at point 342c.

Moreover, the exposure times of the respective imaging apparatuses may not be identical to one another, and the exposure times may not be included entirely within a respective predetermined period (e.g., the first predetermined period). Namely, the exposure period for the second imaging apparatus 204 ends at point 344b, at which point, the imaging shutter for the second imaging apparatus 204 closes to stop the exposure of the imaging sensors of the second imaging apparatus 204. Thereafter, the illumination level provided by the respective illumination pulses ends at point 344a. The exposure period for the first imaging apparatus 202 then ends at point 344c, at which point, the imaging shutter for the first imaging apparatus 202 closes to stop the exposure of the imaging sensors of the first imaging apparatus 202.

However, as illustrated in FIG. 3E, the first imaging apparatus may trigger a subsequent exposure for the corresponding imaging sensors during the subsequent exposure period, in which, no illumination pulse is emitted by the shared illumination source 206. In particular, the first imaging apparatus 202 may trigger the subsequent exposure period at point 346a, and the apparatus 202 may rely on ambient lighting in order to capture image data during the subsequent exposure period. The first imaging apparatus 202 may stop the subsequent exposure at point 348a, at which point, the imaging shutter for the first imaging apparatus 202 closes to stop the exposure of the imaging sensors of the first imaging apparatus 202.

This sequence of the first predetermined period and the subsequent exposure period may repeat iteratively any suitable number of times in order to capture any sufficient number of images (e.g., frames) for any suitable image analysis purposes (e.g., indicia payload decoding, facial recognition, scan avoidance detection, etc.). Thus, in the fifth exemplary activation sequence illustrated in FIG. 3E, the exposure periods for both imaging apparatuses 202, 204 during the first predetermined period may include portions that are not within the first predetermined period (e.g., between point 342 and point 344), and the subsequent exposure for the first imaging apparatus 202 may include a portion that is not within the subsequent exposure period (e.g., between point 346 and point 348) and the apparatus 202 may not receive illumination from the shared illumination source 206 during the subsequent exposure period in any event.

FIG. 3F is a graph 350 illustrating a sixth exemplary activation sequence of a shared illumination source (e.g., shared illumination source 206), a first imaging apparatus (e.g., first imaging apparatus 202), and a second imaging apparatus (e.g., second imaging apparatus 204), in accordance with embodiments disclosed herein. As illustrated in FIG. 3F, the graph 350 includes a first line (I) representing the illumination level provided by the shared illumination source 206, a second line (B) representing the exposure of a barcode imager (e.g., second imaging apparatus 204), and a third line (V) representing the exposure of a visual camera (e.g., first imaging apparatus 202). As previously described, the illumination pulses emitted by the shared illumination source 206 may define predetermined periods, during which, the imaging apparatuses may expose and capture image data. Two such predetermined periods are illustrated in FIG. 3F by the durations delineated by a first time 352 and a second time 354 (e.g., a “first predetermined period”), and a third time 356 and a fourth time 358 (e.g., a “second predetermined period”) including multiple illumination pulses.

At the first time 352, the shared illumination source 206 may emit an illumination pulse, as represented by the increased level of illumination at point 352a on the first line I. In the sixth exemplary activation sequence, the second imaging apparatus 204 may trigger an exposure of the corresponding imaging sensors that is synchronized to this initial illumination pulse emission by the shared illumination source 206, as represented at point 352b. Further, the initial exposure of the first imaging apparatus 202 may not be synchronized with the initial exposure of the second imaging apparatus 204 at point 352b, and instead, the first imaging apparatus 202 may trigger an exposure of the corresponding imaging sensors at point 352c.

Moreover, the exposure times of the respective imaging apparatuses may not be identical to one another, and the exposure times may be included entirely within a respective predetermined period (e.g., the first predetermined period). Namely, the exposure period for the second imaging apparatus 204 ends at point 354b, at which point, the imaging shutter for the second imaging apparatus 204 closes to stop the exposure of the imaging sensors of the second imaging apparatus 204. Thereafter, the illumination level provided by the respective illumination pulse ends at point 354a, and the exposure period for the first imaging apparatus 202 ends simultaneously with the illumination level at point 354c, at which point, the imaging shutter for the first imaging apparatus 202 closes to stop the exposure of the imaging sensors of the first imaging apparatus 202.

However, as illustrated in FIG. 3F, the shared illumination source 206 may emit two subsequent illumination pulses within the second predetermined period, as represented by point 356a1 and point 356a2. The first subsequent illumination pulse emitted at point 356a1 may provide an elevated level of illumination for the second imaging apparatus 204, which may begin a subsequent exposure at point 356b that is synchronized with the emission of the first subsequent illumination pulse. This subsequent exposure of the second imaging apparatus 204 may last as long as the first subsequent illumination pulse provides an elevated level of illumination, such that the subsequent exposure ends at point 358b in a synchronized manner with the end of the first subsequent illumination pulse at point 358a1. Similarly, the second subsequent illumination pulse emitted at point 356a2 may provide an elevated level of illumination for the first imaging apparatus 202, which may begin a subsequent exposure at point 356c that is synchronized with the emission of the second subsequent illumination pulse. This subsequent exposure of the first imaging apparatus 202 may last as long as the second subsequent illumination pulse provides an elevated level of illumination, such that the subsequent exposure ends at point 358c in a synchronized manner with the end of the second subsequent illumination pulse at point 358a2.

More generally, the sixth exemplary activation sequence may represent a circumstance in which the shared illumination source 206 may generate/emit illumination pulses on demand in order to provide illumination for either of the imaging apparatuses 202, 204 at any time. Thus, the sixth exemplary activation sequence may repeat iteratively and/or may include any non-iterative combination of exposure patterns that are synchronized and/or otherwise in combination with an emission of an illumination pulse(s) by the shared illumination source 206. The sixth exemplary activation sequence may also repeat any suitable number of times and/or include any suitable combination of exposures and on-demand illumination pulses in order to capture any sufficient number of images (e.g., frames) for any suitable image analysis purposes (e.g., indicia payload decoding, facial recognition, scan avoidance detection, etc.).

Moreover, it should be appreciated that the exemplary activation sequences described herein are for the purposes of discussion only, and that the shared illumination source 206 and imaging apparatuses 202, 204 may activate in any suitable combination(s) of the predetermined periods and/or exposure periods discussed herein.

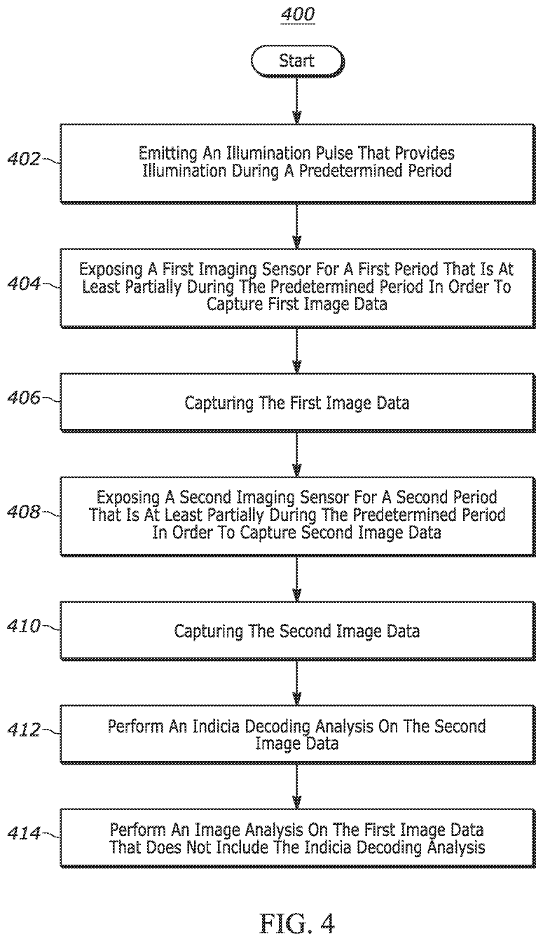

FIG. 4 illustrates an example method 400 for capturing image data by a first imaging apparatus and a second imaging apparatus with a shared illumination source, in accordance with embodiments disclosed herein. The method 400 includes emitting an illumination pulse that provides illumination during an predetermined period (block 402). The illumination pulse may be emitted by a shared illumination source (e.g., shared illumination source 206). In certain embodiments, the illumination source may be configured to emit the illumination pulse that provides illumination lasting the predetermined period.

The method 400 may further include exposing a first imaging sensor (e.g., first imaging sensor 202b) for a first period that is at least partially during the predetermined period in order to capture a first image data (block 404). The first imaging sensor may be included as part of a first imaging apparatus (e.g., first imaging apparatus 202) that has a first FOV (e.g., first FOV 202a), that may also include a first imaging control circuitry (e.g., first imaging control circuitry 202c) configured to expose the first imaging sensor for the first period. In certain embodiments, the first imaging control circuitry is further configured to expose the first imaging sensor for the first period that is at least partially not during the predetermined period.

The method 400 may further include capturing the first image data of a target object (block 406). The method 400 may further include exposing a second imaging sensor (e.g., second imaging sensor 204b) for a second period that is at least partially during the predetermined period in order to capture a second image data (block 408). The second imaging sensor may be included as part of a second imaging apparatus (e.g., second imaging apparatus 204) that has a second FOV (e.g., second FOV 204a), that may also include a second imaging control circuitry (e.g., second imaging control circuitry 204c) configured to expose the second imaging sensor for the second period. In certain embodiments, the first FOV is larger than the second FOV.

In some embodiments, the first imaging apparatus and the second imaging apparatus are configured to transmit an exposure signal to the illumination source in order to cause the illumination source to emit the illumination pulse when (i) the first imaging control circuitry exposes the first imaging sensor for the first period or (ii) the second imaging control circuitry exposes the second imaging sensor for the second period.

In certain embodiments, the first period may be greater than the second period, and the predetermined period is based on the first period. However, in some embodiments, the second imaging control circuitry may be further configured to expose the second imaging sensor for the second period that is at least partially not during the predetermined period.

In some embodiments, the first imaging control circuitry may be configured to expose the first imaging sensor for the first period that is entirely during the predetermined period, and the second imaging control circuitry may be configured to expose the second imaging sensor for the second period that is entirely during the predetermined period. Further in these embodiments, the first imaging control circuitry may be configured to expose the first imaging sensor at a first time defining a beginning of the first period, and the second imaging control circuitry may be configured to expose the second imaging sensor at a second time defining a beginning of the second period that is different from the beginning of the first period.

In certain embodiments, the illumination source (e.g., shared illumination source 206) may be configured to emit a plurality of illumination pulses that each provide illumination during a respective predetermined period. In these embodiments, the first imaging control circuitry may be configured to expose the first imaging sensor for the first period during a first respective predetermined period, and the illumination provided during the first respective predetermined period may have a first brightness. Further in these embodiments, the second imaging control circuitry may be configured to expose the second imaging sensor for the second period that is different from the first period, and that is during a second respective predetermined period that is different from the first respective predetermined period. Moreover, the illumination provided during the second respective predetermined period may have a second brightness that is different from the first brightness.

In some embodiments, the first imaging control circuitry may be configured to expose the first imaging sensor in response to a signal generated by the illumination source upon emission of the illumination pulse, and the second imaging control circuitry is configured to expose the second imaging sensor in response to the signal generated by the illumination source upon emission of the illumination pulse.

The method 400 may further include capturing the second image data of an indicia associated with the target object (block 410). In some embodiments, the first imaging sensor and the second imaging sensor are color imaging sensors, and the illumination source comprises three light sources that each emit a distinct wavelength at a respective predetermined intensity, such that a combined output of the three light sources causes the illumination pulse to provide a white appearance to a user that lasts the predetermined period. However, in certain embodiments, the second imaging sensor may include a monochrome sensor. Further, in some embodiments, the first imaging sensor and the second imaging sensor may be a single imaging sensor.

The method 400 may further include performing an indicia decoding analysis on the second image data (block 412). The method 400 may further include performing an image analysis on the first image data that does not include the indicia decoding analysis (block 414). In certain embodiments, the processor(s) may perform the image analysis on the first image data that includes at least one of: (i) facial recognition, (ii) scan avoidance detection, (iii) ticket switching detection, (iv) item recognition, or (v) video feed analysis.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging system comprising:
an illumination source configured to emit an illumination pulse that provides illumination during a predetermined period;
a first imaging apparatus having a first field of view (FOV), comprising:
a first imaging sensor configured to capture first image data representative of an environment appearing within the first FOV during a first period that overlaps at least partially with the predetermined period, and
a first imaging control circuitry configured to expose the first imaging sensor for the first period in order to capture the first image data;
a second imaging apparatus having a second FOV that at least partially overlaps the first FOV, comprising:
a second imaging sensor configured to capture second image data representative of an environment appearing within the second FOV during a second period that overlaps at least partially with the predetermined period, and
a second imaging control circuitry configured to expose the second imaging sensor for the second in order to capture the second image data; and
a processor configured to:
receive the first image data from the first imaging apparatus and the second image data from the second imaging apparatus,
perform an indicia decoding analysis on the second image data, and
perform an image analysis on the first image data that does not include the indicia decoding analysis.

2. The imaging system of claim 1, wherein the first period is greater than the second period, and the predetermined period is based on the first period.

3. The imaging system of claim 1, wherein the first imaging control circuitry is further configured to expose the first imaging sensor for the first period that is at least partially not during the predetermined period.

4. The imaging system of claim 1, wherein the second imaging control circuitry is further configured to expose the second imaging sensor for the second period that is at least partially not during the predetermined period.

5. The imaging system of claim 1, wherein the first imaging sensor and the second imaging sensor are color imaging sensors, and
wherein the illumination source comprises three light sources that each emit a distinct wavelength at a respective predetermined intensity, such that a combined output of the three light sources causes the illumination pulse to provide a white appearance to a user that lasts the predetermined period.

6. The imaging system of claim 1, wherein the second imaging sensor is a monochrome imaging sensor.

7. The imaging system of claim 1, wherein the first imaging control circuitry is configured to expose the first imaging sensor for the first period that is entirely during the predetermined period, and the second imaging control circuitry is configured to expose the second imaging sensor for the second period that is entirely during the predetermined period.

8. The imaging system of claim 7, wherein the first imaging control circuitry is configured to expose the first imaging sensor at a first time defining a beginning of the first period, and the second imaging control circuitry is configured to expose the second imaging sensor at a second time defining a beginning of the second period that is different from the beginning of the first period.

9. The imaging system of claim 1, wherein the first imaging sensor and the second imaging sensor are a single imaging sensor.

10. The imaging system of claim 1, wherein the illumination source is further configured to emit the illumination pulse that provides illumination lasting the predetermined period.

11. The imaging system of claim 1, wherein the first FOV is larger than the second FOV.

12. The imaging system of claim 1, wherein the processor is further configured to:
perform the image analysis on the first image data that includes at least one of: (i) facial recognition, (ii) scan avoidance detection, (iii) ticket switching detection, (iv) item recognition, or (v) video feed analysis.

13. The imaging system of claim 1, wherein:
the illumination source is configured to emit a plurality of illumination pulses that each provide illumination during a respective predetermined period,
the first imaging control circuitry is configured to expose the first imaging sensor for the first period during a first respective predetermined period,
the illumination provided during the first respective predetermined period has a first brightness, the second imaging control circuitry is configured to expose the second imaging sensor for the second period that is different from the first period, and that is during a second respective predetermined period that is different from the first respective predetermined period, and
the illumination provided during the second respective predetermined period has a second brightness that is different from the first brightness.

14. The imaging system of claim 1, wherein the first imaging control circuitry is configured to expose the first imaging sensor in response to a signal generated by the illumination source upon emission of the illumination pulse, and the second imaging control circuitry is configured to expose the second imaging sensor in response to the signal generated by the illumination source upon emission of the illumination pulse.

15. The imaging system of claim 1, wherein the first imaging apparatus and the second imaging apparatus are configured to transmit an exposure signal to the illumination source in order to cause the illumination source to emit the illumination pulse when (i) the first imaging control circuitry exposes the first imaging sensor for the first period or (ii) the second imaging control circuitry exposes the second imaging sensor for the second period.

16. A tangible machine-readable medium comprising instructions that, when executed, cause a machine to at least:
emit an illumination pulse that provides illumination during a predetermined period;
expose a first imaging sensor for a first period that is at least partially during the predetermined period in order to capture first image data representative of an environment appearing within a first field of view (FOV);
expose a second imaging sensor for a second period that is at least partially during the predetermined period in order to capture second image data representative of an environment appearing within a second FOV;
perform an indicia decoding analysis on the second image data; and
perform an image analysis on the first image data that does not include the indicia decoding analysis.

17. The tangible machine-readable medium of claim 16, wherein the first period is greater than the second period, and the predetermined period is based on the first period.

18. The tangible machine-readable medium of claim 16, wherein the instructions, when executed, further cause the machine to at least:
expose the first imaging sensor for the first period that is at least partially not during the predetermined period, and
expose the second imaging sensor for the second period that is at least partially not during the predetermined period.

19. The tangible machine-readable medium of claim 16, wherein the instructions, when executed, further cause the machine to at least:
expose the first imaging sensor for the first period that is entirely during the predetermined period, wherein the first imaging sensor is exposed at a first time defining a beginning of the first period, and
expose the second imaging sensor for the second period that is entirely during the predetermined period, wherein the second imaging sensor is exposed at a second time defining a beginning of the second period that is different from the beginning of the first period.

20. The tangible machine-readable medium of claim 16, wherein the instructions, when executed, further cause the machine to at least:
emit a plurality of illumination pulses that each provide illumination during a respective predetermined period,
expose the first imaging sensor for the first period during a first respective predetermined period, wherein the illumination provided during the first respective predetermined period has a first brightness, and
expose the second imaging sensor for the second period that is different from the first period, and that is during a second respective predetermined period that is different from the first respective predetermined period, wherein the illumination provided during the second respective predetermined period has a second brightness that is different from the first brightness.
